(19) United States
(12) Patent Application Publication
(10) Pub. No.: US 2010/0036713 A1
(43) Pub. Date: Feb. 11, 2010

(54) COLLECTING PERSONAL DATA FROM A USER AND SHARING REVENUE GENERATED FROM THE SALE OF THE PERSONAL DATA

(76) Inventor: Dung-Yuan Tang, Pleasanton, CA (US)

Correspondence Address: HAHN AND MOODLEY, LLP, 548 Market Street, San Francisco, CA, 94104, US

(21) Appl. No.: 12/539,562

(22) Filed: Aug. 11, 2009

Related U.S. Application Data
(60) Provisional application No. 61/087,964, filed on Aug. 11, 2008.

(51) Int. Cl. G06Q 30/00; G06Q 10/00

(52) U.S. Cl. 705/10; 705/1

(57) ABSTRACT

In one embodiment a personal data portal is provided to collect personal data associated with a user. The personal data may be of interest to third parties such as marketers. The personal data may be generated through the normal use of personal data generation devices such as mobile phones, navigation systems, personal computers, payment transponders, etc. As such, the personal data may include physical locations visited by the user, virtual locations (websites) visited by the user, telephone numbers dialed by the user, payment transactions for the user, etc. Access to the collected personal data is provided to the third parties for a fee. Advantageously, at least a part of the fee may be shared with the user.

This application claims the benefit of priority to U.S. 61/087,964 filed Aug. 11, 2008, and entitled Organising And Monetizing Personal Data, the entire specification of which is incorporated herein by reference.

### FIELD

Embodiment of the present invention relate to a method and system for managing various personal location data assets.

### BACKGROUND

Each day, an individual generates massive amounts of personal data that is of interest to third parties such as marketers.

The personal data may be generated through the normal use of mobile phones, Global Positioning System (GPS) navigation systems, payment transponders, and Internet Service Providers (ISPs), etc.

Typically, said personal data is purchased from companies that specialize in the collection of the data.

### SUMMARY

In one embodiment a personal data portal is provided to collect personal data associated with a user. The personal data may be of interest to third parties such as marketers. The personal data may be generated through the normal use of personal data generation devices such as mobile phones, navigation systems, personal computers, payment transponders, etc. As such, the personal data may include physical locations visited by the user, virtual locations (websites) visited by the user, telephone numbers dialed by the user, payment transactions for the user, etc. Access to the collected personal data is provided to the third parties for a fee. Advantageously, at least a part of the fee may be shared with the user.

### BRIEF DESCRIPTION OF THE DRAWINGS

FIG. 1 illustrates a method for collecting and monetizing personal data, in accordance with one embodiment of the invention.

FIG. 2 shows a block diagram of a system for a personal data portal, in accordance with an example embodiment.

### DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment a personal data portal is provided to collect personal data associated with a user. The personal data may be of interest to third parties such as marketers. The personal data may be generated through the normal use of personal data generation devices such as mobile phones, navigation systems, personal computers, payment transponders, etc. As such, the personal data may include physical locations visited by the user, virtual locations (websites) visited by the user, telephone numbers dialed by the user, payment transactions for the user, etc. Access to the collected personal data is provided to the third parties for a fee. Advantageously, at least a part of the fee may be shared with the user.

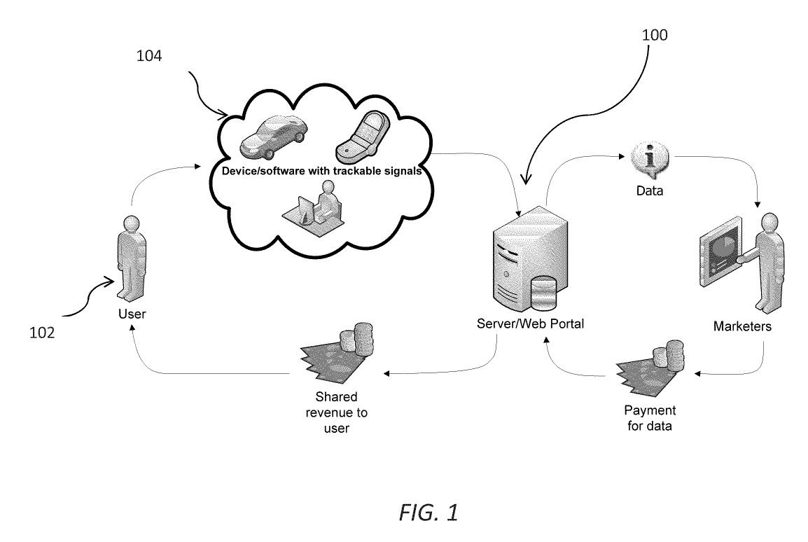

FIG. 1 illustrates how a personal data portal 100 may be used to collect and monetize personal data, in accordance with one embodiment of the invention. To begin—a user 102 registers a user profile on the portal 100. In accordance with one embodiment, the user profile may include profile data such as age, profession, etc. During the registration process, the user 102 may select appropriate privacy and marketing options to control to whom and under what terms and conditions the user's personal data may be sold.

Next, the user 102 registers at least one associated personal data generation device that which will be used to generate the personal data. For example, said devices may include mobile phones (equipped with a GPS sensor), an in-car GPS system, or a web browser/computer ID. The registration step is indicated by reference numeral 104 in FIG. 1.

After each device has been registered, the system (portal 100) will start collecting data generated by each registered device when the device is used. For this step, each registered device transmits data to the portal 100 via a communications channel with the portal 100. In accordance with embodiments of the invention, the communications channel may include a wired or a wireless network connection with the portal 100

From the data collected, a user can visit the portal to get a better understanding of his/her habits such as travelling patterns etc., and make appropriate changes to the habits based on say an efficiency analysis of the habits.

In one embodiment the portal 100 may be configured to import other data for cross referencing purposes. This other data may include electronic bank/credit card statements, mobile phone calling records, etc.. By cross referencing with a 2^{nd}/3^{rd}/4^{th} data source, a user can get a delta on his pattern and further optimize the efficiency analysis.

In one embodiment, the portal 100 also allows a user to enter other data attributes, for example, “I came to this restaurant for my birthday”, “I came to this store to buy Christmas gifts”, “I am the member of this golf club”, “I like the quality of service”, “This is my favorite restaurant—they are a bit expensive”, etc. This rating and comment information is shared to provide additional suggestions for other users whom also frequent the same route or are looking for recommendations is a certain area.

It will be appreciated that the collected data represents valuable information for marketers. In one embodiment, the collected data may be searchable based on sorted parameters and purchased directly from the system. The profile data entered by each user makes the collected data even more valuable than just raw data without classification parameters.

In one embodiment, when the data has been purchased from the system, each of the users, who is ultimately responsible for generating the data, will get a share of the profit generated from the purchase.

In one embodiment, the users that have spent more time in refining the data by cross referencing with additional data sources and providing ratings and comments will also get paid more for the time/effort invested into the system as this type of data is more refined and holds higher value than just pure time/location data.

Advantageously, beside the financial gain to the user, this approach ensures privacy of personal data and each user ultimately has complete control over how the personal data/information is used and marketed.

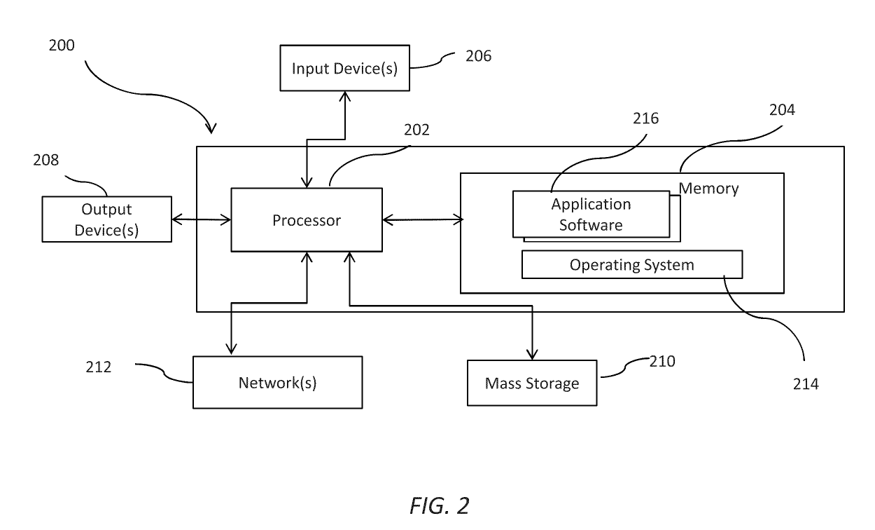

FIG. 2 of the drawings shows an example of a system 200 that may be used to implement the portal 100, in accordance with one embodiment. The system 200 may include at least one processor 202 coupled to a memory 204. The processor 202 may represent one or more processors (e.g., microprocessors), and the memory 204 may represent random access memory (RAM) devices comprising a main storage of the system 200, as well as any supplemental levels of memory e.g., cache memories, non-volatile or back-up memories (e.g. programmable or flash memories), read-only memories, etc. In addition, the memory 204 may be considered to include memory storage physically located elsewhere in the system 200, e.g. any cache memory in the processor 202 as well as any storage capacity used as a virtual memory, e.g., as stored on a mass storage device 210.

The system 200 also typically receives a number of inputs and outputs for communicating information externally. For interface with a user or operator, the system 200 may include one or more user input devices 206 (e.g., a keyboard, a mouse, imaging device, etc.) and one or more output devices 208 (e.g., a Liquid Crystal Display (LCD) panel, a sound playback device (speaker, etc)).

For additional storage, the system 200 may also include one or more mass storage devices 210, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 620 may include an interface with one or more networks 212 (e.g., a local area network (LAN), a wide area network (WAN), a wireless network, and/or the Internet among others) to permit the communication of information with other computers coupled to the networks. It should be appreciated that the system 200 typically includes suitable analog and/or digital interfaces between the processor 202 and each of the components 204, 206, 208, and 212 as is well known in the art.

The system 200 operates under the control of an operating system 214, and executes various computer software applications, components, programs, objects, modules, etc. to implement the techniques described above. Moreover, various applications, components, programs, objects, etc., collectively indicated by reference 216 in FIG. 2, may also execute on one or more processors in another computer coupled to the system 200 via a network 212, e.g. in a distributed computing environment, whereby the processing required to implement the functions of a computer program may be allocated to multiple computers over a network. The application software 216 may include a set of instructions which, when executed by the processor 202, causes the system 200 to implement the method of the invention.

1. A method, comprising:
performing a registration operation wherein a user registers a user profile for the collection of personal data, the user profile having associated therewith at least one device capable of generating at least some of the personal data;
storing personal data received via the at least one data device;
allowing access to the personal data to a third party for a fee; and
sharing at least part of the fee with the user.

2. The method of claim 1, further comprising allowing the user to associate an annotation with at least some of the personal data.

3. The method of claim 2, wherein the annotation comprises a rating.

4. The method of claim 2, wherein the annotation comprises a comment.

5. The method of claim 2, further comprising cross referencing the personal data with at least one other data source associated with the user.

6. The method of claim 5, wherein the at least one other data source is selected from the group consisting of a credit card statement, a bank statement, and a mobile phone call record.

7. The method of claim 1, wherein the device is selected from the group consisting of a mobile phone, a navigation device, and a personal computer.

8. The method of claim 2, wherein the sharing comprises paying a higher amount to the user if the user has annotated the personal data.

9. A server, comprising:
a processor; and
a memory coupled to the processor, the memory storing instructions which when executed by the processor causes the server to perform a method, comprising:
performing a registration operation wherein a user registers a user profile for the collection of personal data, the user profile having associated therewith at least one device capable of generating at least some of the personal data;
storing personal data received via the at least one data device;
allowing access to the personal data to a third party for a fee; and
sharing at least part of the fee with the user.

10. The server of claim 9, further comprising allowing the user to associate an annotation with at least some of the personal data.

11. The server of claim 10, wherein the annotation comprises a rating.

12. The server of claim 10, wherein the annotation comprises a comment.

13. The server of claim 10, further comprising cross referencing the personal data with at least one other data source associated with the user.

14. The server of claim 13, wherein the at least one other data source is selected from the group consisting of a credit card statement, a bank statement, and a mobile phone call record.

15. The server of claim 9, wherein the device is selected from the group consisting of a mobile phone, a navigation device, and a personal computer.

16. The server of claim 10, wherein the sharing comprises paying a higher amount to the user if the user has annotated the personal data.

17. A computer-readable medium having stored thereon a sequences of instructions which when executed by a server causes the server to perform a method, comprising:
performing a registration operation wherein a user registers a user profile for the collection of personal data, the user profile having associated therewith at least one device capable of generating at least some of the personal data;
storing personal data received via the at least one data device;
allowing access to the personal data to a third party for a fee; and
sharing at least part of the fee with the user.

18. The computer-readable medium of claim 17, further comprising allowing the user to associate an annotation with at least some of the personal data.

19. The computer-readable medium of claim 18, wherein the annotation comprises a rating.

20. The computer-readable medium of claim 18, wherein the annotation comprises a comment.
